(19) United States
(12) Patent Application Publication
(10) Pub. No.: US 2019/0131026 A1
(43) Pub. Date: May 2, 2019

(54) Controlled Pion - Electron Interactions to Produce: 1) Electricity (Claim 1); 2) Coherent Gamma Ray Beam (Claim 2); and 3) Proton to Neutron Transmutations (Claim 3)

(71) Applicants: William Thomas Gray, Menlo Park, CA (US); Matthew William Gray, Sacramento, CA (US)

(72) Inventors: William Thomas Gray, Menlo Park, CA (US); Matthew William Gray, Sacramento, CA (US)

(21) Appl. No.: 15/796,700

(22) Filed: Oct. 27, 2017

(51) Int. Cl. G21G 1/02; H05H 6/00; H05H 5/08; G21B 3/00

(52) U.S. Cl. CPC G21G 1/02; G21B 3/006; H05H 5/08; H05H 6/005

(57) ABSTRACT

This invention produces electricity, gamma rays, or neutrons, based on the findings set forth in A Nuclear-Gravitational Electrodynamic Framework, Boltzmann's P=e^{S/k} probability principle, Maxwell's EM theory, Relativity, and Quantum Theory, to optimize protons' pion-electron interactions. Functionally this is like what occurs in Chemical Thermodynamics, using external conditions to control 10⁻¹⁰ m orbital electron interactions to rearrange molecules and obtain desired products, except that this process controls 10⁻¹⁵ m pion-electron interactions by creating an equilibrium between external EM conditions and protons' internal components to control the protons' pion generation.

### CROSS REFERENCE TO RELATED APPLICATIONS

No other methods of controlled pion-electron interactions to produce a Beta particle beam to generate electricity, to produce a coherent gamma ray beam, and to transmute protons to neutrons by exciting proton Up quarks into Down quarks were found to exist. Research into low yield quantum statistical pion-pion and pion-nucleon interactions exists, but the pion-electron interactions in this patent application refer to the proton's quark based pion generation in A Nuclear-Gravitational Electrodynamic Framework (Copyright: TXu001945507/2014-11-03). This model shows that proton mass, charge, magneton, ½-spin, density and pion generation is an integrated process that supports high yield control of pion-electron interactions to produce electricity, a gamma ray beam, and neutrons.

Statement of federally sponsored research or development: There is no federally sponsored research or development involved in this patent.

Names of the parties to a joint research agreement if the claimed invention was made as a result of activities within the scope of a joint research agreement:

| William Thomas Gray | Matthew William Gray |
|---|---|
| 415 Lemon St. | 960 Castec Dr. |
| Menlo Park, CA 94025 | Sacramento, CA 95864 |
| bill@mqnf.com | matt@mqnf.com |
| (650) 785-5648 | (916) 485-4747 |

Referenced Material: A Nuclear-Gravitational Electrodynamic Framework (Copyright: TXu001945507/2014-11-03), available at www.QuantumEnergySystems.com

Background of the invention: Since Electron Capture transmutes protons into neutrons with uniform 939.556 MeV ground state mass-energies, and proton-neutron interactions result in uniform pion based 2.224 MeV ground state bond energies, it was concluded that these phenomena result from continuously predictable non-statistical ground state processes; and since

Neutrons and proton-neutron bonds also exhibit excited energy states, in accordance with Boltzmann's P=e^{S/k} probability principle, it was further concluded that these phenomena constitute integrated quantum systems with continuously predictable non-statistical ground and light speed state boundary conditions; and since

Particles, atoms and gravitational bodies are coincident nuclear-gravitational systems governed by Einstein's γ=√(1−v²/c²) Lorentz transformation, and Sommerfeld's α=e²/2εₒhc fine structure constant describes hydrogen's ground to light speed state ratio, then all nuclear-gravitational systems must have the same γₒ=√(1−v²/c²)=√(1−α²) ground to light speed Lorentz transformation range; and as such

Nuclear-gravitational systems do not have 0-velocity ground states, but instead have continuously analytic Cauchy-Riemann

$$\frac{\partial u}{\partial x} = \frac{\partial v}{\partial y} , \frac{\partial u}{\partial y} = - \frac{\partial v}{\partial x} √ {E}_{o}$$

ground and √E_{c} light speed state energy root boundaries with

$${α}^{2} = \frac{{E}_{o}}{{E}_{c}}$$

energy ranges, and thus;

Particles exhibit Schrodinger Eₙ=Eₒ/n² quantum states satisfying Cauchy-Riemann equations with continuous 2^{nd} order differential

$$\frac{{\partial }^{2} u}{\partial {x}^{2}} + \frac{{\partial }^{2} u}{\partial {y}^{2}} = 0 = \frac{{\partial }^{2} v}{\partial {x}^{2}} + \frac{{\partial }^{2} v}{\partial {y}^{2}}$$

Laplacian harmonics, such that Eₒ/n² quantum states are Laplacian harmonics with real and imaginary parts in 2 dimensions;

This points to an Electromagnetic field energy basis of matter, since Einstein's space time exists as both μₒε_{O} impedance and 4-D Minkowski space-time that c=1√(μₒεₒ) EM field energy operates on and nuclear-gravitational energy constructs exist within, so Wave-Particle Duality is a light speed energy resonance between spatial field and particle construct energy states, per Boltzmann's P=e^{S/k} principle, where S defines the field and construct entropic states and k is the particle's mass-energy. Particles are thus light speed energy resonances between wave field and particle construct states, and since this occurs at light speed there is always a′'/2-wave Heisenberg Uncertainty as to its state, since there is nothing faster than light by which to resolve the state of a light speed energy resonance, so particle energy will always exhibit an unresolvable Wave-Particle Duality behavior; and

The one equation set that mathematically resolves light speed Wave-Particle Duality, Schrödinger Eₒ/n² states, coincident α²=Eₒ/E_{c} energy densities, and γₒ=√(1−α²) Lorentz behavior, are e^{x} equations in which x=x for ex energy space-time transforms, x=−ix for e^{-ix} stable negative energy well ground states, x=ix for excited e^{ix}=cos×+i sin×quantum states, and e^{S/k} excited state energy distributions (i.e. Occam's Razor: The simplest explanation to account for all facts is most likely correct); and

Since

$${e}^{x} = 1 + \frac{x}{1 !} + \frac{{x}^{2}}{2 !} + \frac{{x}^{3}}{3 !} + …$$

is a convergent power series, each element adding an energy degree of freedom by integration of the prior element, the particle, atom and gravitational ground state energy constructs reduce to a point, linear, angular and spherical momentum energy progression in Einstein space-time;

This innovative equation set yielded the correct particle mass, construct and wave field energy radii, (A Nuclear-Gravitational Electrodynamic Framework, p. 21-6, and Table 1), and magneton, ½-spin, and density energies, as shown below:

| Matter | | Quantum Optical | Interactive Wave |
|---|---|---|---|
| Constructs | Mass-Energy | Construct Radius | Field Energy Radius |
| Impedance of | hc = h/(μₒεₒ)^{1/2} = (½e [symbol] )^{1/2}/2α = | | |
| space | 1.986445684 × 10⁻²⁵ J · m | | |
| Electron | mₑ = (½e [symbol] ) (α/hc) 3^{2/3} √2 = | rₑₒ = (hc/α²) √3 π = | rₑᵢ = (rₑₒ/α) 3 |
| | 9.129378 × 10⁻³¹ kg | 2.03 × 10⁻²⁰ m | (√2√3)² = 5 × 10⁻¹⁷ m |
| Up Quark* | m_{Up} = (E_{c} − Eₒ) √2√3 2π = | r_{qo} = (hc/α³) π/2 = | r_{qi} = (r_{qo}/α)/√3 = |
| | ½mₑc² √2√3 2π = 3.9322 MeV | 0.803 × 10⁻¹⁸ m | 6.353 × 10⁻¹⁷ m |
| Down Quark* | m_{Down} = √3 mUp = 6.8108 MeV | r_{qo} | r_{qi} |
| Proton | mₚ = (½e [symbol] ) √2√3 3c³ = | rₚₒ = r_{qi} 3^{2/3} 2π = | rₚᵢ = (hc/α⁴)π²3^{2/3}/√2 = |
| | √3{(mUp/α) + (mDown − m_{Up})} = | 0.83 fm | 1.02 fm |
| | 1.673 × 10⁻²⁷ kg = 938.3 MeV | | |
| Higgs Boson | m_{HB} = {mₚ − √3(2mUp + m_{Down})}/ | rₚₒ = r_{qi} 3^{2/3} 2π = | |
| | α = 125.1 GeV | 0.83 fm | |
| Hydrogen Atom | Eₒ = (½e [symbol] ) 3^{2/3} (α³/hc)/√2 = | rₕₒ = h/mₑcα2π = | |
| | 2.43 × 10⁻³⁵ kg = 13.636 MeV | 0.529 Å | |
| Orbital | E_{g} = √3/(½e [symbol] )2π = 3.263 × 10⁵² eV | Light Year = | |
| Gravitational | GMmₑ/rₑₛ = 5.3 × 10³³ J = | 3^{4/3} √2π/2rpi = | |
| Energy and Size | 3.312 × 10⁵² eV | 9.451 × 10¹⁵ m | |

Note on quark values: The 3.9322 Me3V Up and 6.8107 MeV Down mass-energy values differ significantly from the more generally accepted Particle Data Group's 2.3 MeV Up and 4.8 MeV Down quark “estimates of so-called ‘current-quark masses,’” derived as multiple measurement and analysis approach averages (ref K. A. Olive et al. (Particle Data Group), Chin. Phys. C38, 090001 (2014)). The Group's values are correct, but their interpretation is incomplete. They are trying to make quarks fit the criteria of being particles with a specific mass, when in fact they are dynamic energy functions, existing as functional components of larger composite constructs like the proton (i.e. a pendulum's energy is a periodic energy resonance function that depends upon the circumstance of a pendulum, but without this unique function, no pendulum configuration could function).

Only Up and Down quarks were derived because only electrons, protons and neutrons need be considered for a complete model. The only stable particles in the Universe are the electron and proton, and the neutron is their semi-stable composite function which stabilizes nuclei configurations. All other particles are unstable excited electron or proton states that instantly decay, as do their strange, charm, bottom and top excited quark state component functions. Only the minimum needed for a description of the entire framework is stated.

The 3.98 MeV Up quark of Table 1 is the 2π wave function of a ground state orbital electron's maximum possible (E._{c}−Eₒ) light speed relativistic energy, with √2 angular and √3 spherical momentums. The Group's 2.3 MeV average measured Up quark value is the (E_{c}−Eₒ) 2π√2=2.27 MeV light speed orbital without the √3 spherical momentum element. Similarly, the √3 (3.98 MeV)=6.89 MeV Down quark is simply an Up quark's √3 excited state, and the Group's 4.8 MeV value is the 6.89 MeV Down quark absent its √2 angular momentum element. Their measured values are like average pendulum swing values, absent the mass fall and swing functions that make it a pendulum. The Table 1 Up and Down quarks are the integrated components of a continuous framework that starts with space's impedance and ends with 4-D space-time's gravity forces and light year distances, so they include the elements that integrate them into the continuum of the framework.

To fit the criteria of this pattern, the proton is viewed as a composite function of the electron function, such that the quarks are the maximum excited energy states of the electron and the nuclear, atomic and gravitational energy domains are coincident structures that adhere to Einstein's γ=√(1−α²) Lorentz space- time-mass transformation, where a defines the ground to light speed state ratio for each of them. Thus, the Up quark is viewed as an electron's ½ mec²=0.255 MeV maximum relativistic energy, as a 2π wave function with √2 angular and √3 spherical momentum energy distributions, so m_{Up}=(½mₑc²) √2 √3 2π=3.9323 MeV is the Up-quark function and m_{Down}=√3 mUp=6.8109 MeV is the Up-quark's minimum 3-D excited state energy necessary for them to function as a proton resonant orbital triton component.

If the ground and light speed state boundaries are continuously analytic for quantum statistical P=e^{S/k} systems, then their ground and light speed states will accord with classical physics. It is not possible to directly measure light speed boundaries because of Heisenberg's ½-wave Uncertainty, however both classical and quantum systems are orbital in nature, the ground and light speed states are minimum and maximum system energies, so there is no extra energy for statistical behavior in either case. Also, nuclear-gravitational systems are coincident, the gravitational domain predominantly existing as orbital ground states, and this linear, angular, spherical momentum approach agrees with empirical measurements.

The proton's three quarks were modeled in their minimum possible energy construct, three 3.9322 MeV Up quarks bound in a triton configuration by a m_{Down}−m_{Up}=(√3−1) m_{Up}=2.8786 MeV gluon that carries the excited Down quark state to each Up quark at the speed of light to dynamically form a 6.8109 MeV Down quark that transitions between the Up quarks with a ground state angular momentum, as shown in FIG. 1: Quark Triton.

Light speed impact of a 2.8786 MeV Down quark state gluon with each Up quark, at 0 relative velocity with respect to the gluon, generates a 135 MeV π^{O} impulse energy, according to

$${m}_{{π}^{o}} = \sqrt{\frac{3}{2}} \{ ( \frac{3}{α} ) ( \frac{1}{2} {m}_{e} {c}^{2} ) + \sqrt{2} {m}_{e} \} + ( {m}_{Down} - \frac{{m}_{Up}}{π} ) = 135 MeV .$$

The m₉₀^{o}=135 MeV energy elements result from energy's P=e^{S/k} circumstances: The k energy component will fill every available S degree of freedom, so if light speed is available to an mₑₒ ground state electron in 4-D space-time, it will achieve it, and, ½mₑc²=E_{c}−E₀=0.2555 MeV is the basis of m_{Up}=½mₑc²√2 √3 2π=3.9322 MeV quark, m_{μ}=3(½mₑc²)/α=105 MeV muon, and mπ^{O}=√(3/2) {3(½mₑc²)/α+√2mₑ}+(m_{Down}−m_{Up}/π)=135 MeV pion ground state uniformity.

Quark triton stability is sustained by the Higgs boson mass energy generation, part of an integrated process that generates the proton's charge, magneton, ½-spin and size. The mₚ=(½eℏ) √2√3 3c³=√3 {(m_{Up}/α)+(m_{Down}−m_{Up})}=1.673×10⁻²⁷ kg =938.3 MeV is a composite balance between space's (½eℏ) impedance energy and the Up quarks and gluon entropic degrees of freedom in 4-D space-time that operate upon it.

In the Standard Model, Up and Down quarks are respectively assigned +⅔ and −⅓ e charges, which gives a proton with 2 Up quarks and 1 Down quark a +1e charge, but this fails to comport to empirical data. In magnetic fields, charged particles in motion physically curve per the Right-Hand Rule, which points to an orientation based charge polarity if Einstein's “field free” 4-D Minkowski space-time is correct, as shown in FIG. 2, Impedance of Space.

Einstein constructed 4-D space-time out of 3-D spatial x, y, z points separated by the t time it takes for energy to travel between them at light speed, and then superimposed a “Riemann condition” field gradient to represent gravity, derived from his Lorentz space-time-mass transformation in Electrodynamics of Moving Bodies, which applied to Electromagnetic fields, and thus required bipolar polarities, as shown in FIG. 2-b.

This would require the points of space to be constructed of polar halves that can form ↑↓, (positive), ↑↓, (neutral) and ↓↓ (negative) states at light speed so as to constitute an Wave-Particle Duality EM field energy entropic degree of freedom, with each ½point having an hc=h/(μₒε_{O})^{1/2}=(½eℏ)^{1/2}/2α=1.986445684×10⁻²⁵ J·m impedance energy.

This innovative and new tristate impedance of space model satisfies Einstein's criteria in Electrodynamics of Moving Bodies that a moving magnet produce an electric field while a stationary one creates and electromotive force, it accommodates Relativity, quantum states, and orientation based integral charges, but not the Standard Model's +⅔ Up and −⅓ Down quark charges observed in Quantum Optics, unless one recognizes that a light speed transfer of the Down quark state between the 3 Up quarks will result in a -le Down quark charge and state ⅓ of the time for each Up quark, which will quantum optically observe as a sub light speed average of two+⅔ Up and one −⅓ Down quark charges.

This divergence from previously accepted theories is because Boltzmann's P=e^{S/k} probability principle requires energy distribution in all degrees of freedom over time, even at ground state, which translates to light speed linear, angular and spherical momentums in 3-D space; so, the triton's planar construct would rotate spherically at light speed, moving in space with an average +1e charge, but which statistically appears as +⅔e and −⅔e in quantum optic particle interactions, as shown in FIG. 3, Quark Triton Generated Higgs Mass.

As the +1e triton moves through ↓↑ neutral space it induces an oriented ↑↑ magnetic field that causes it to curve about the field at light speed (FIG. 3). This construct then rotates spherically at light speed to distribute its energy per P=e^{S/k}, creating a field mass energy with poles that rotate at light speed, per c=1/√μ_{O}ε_{O} and m=½eℏ/μ, an inverse Bohr magneton, withμ as the triton light speed motion generated magneton. Light speed pole reversal is too rapid for detection by electron motion in a coil because Relativity geometrically impedes motion, and any generated motion will be cancelled by the opposing pole a ½ cycle later. Einstein also showed that EM field motion through space has the same “inertial” Lorentz transformation effects as mass.

To be stable, the triton charge wavelength propagating through the mass must equate to the triton traversing half its circumference at light speed, so the ↑e⁺ charge motion force on one side can attract its opposing ↓e⁺ charge motion force. If E=hf=hc/λ (Planck's equation), then a √3(2mUp+m_{Down})=25.4 MeV=4.07×10⁻¹² J triton with √2√3 angular and spherical momentums will generate a 2π wavelength of λ=hc/E=ℏc/[√3(2mUp+m_{Down})√2√3 2π]=1.00942×10⁻¹⁵ m, a rₚᵢ=(hc/α⁴)π²3^{2/3}·2=1.02 fm proton radius minus the triton's r_{qi}=(r_{qo}/α)√3=6.35×10⁻¹⁷ m quark radii.

This relation between wavelength and dimension explains the proton's ground state size in terms of classical EM theory, since the ground state is the boundary of its quantum behaviors, and explains why it has a 2.78 times greater magneton than the μₚ=½eℏ/mp Bohr magneton relation says it should. The Bohr equation shows that mass energy attenuates the ½eℏ magneton, but not why. The framework shows that proton mass-energy is magnetic field energy generated by the orbital triton charge, and as EM energy, it will attenuate the magneton generated by the triton by absorbing it per its density ratio with respect to the electron, the ratio of their masses and radii cubed, so μₚ=½eℏ/mp {(rₚᵢ/rₑᵢ)³/(mₚ/mₑ)}/√3=2.7. If the actual proton radius is 1.035 fm, 1.5% greater than the calculated value, the measured 2.78 times greater magneton results, 2.78×√3=4.8 times greater in the spin vector.

The proton's ½-spin is caused by relativistic shift of the mass center by contraction of space by the light speed triton. Since the mass radius is rₚₒ=0.83 fm and the triton orbital radius occurs at the rₚᵢ=1.02 fm, the spin offset angle is arc sin rₚₒ/rₚᵢ=54.7°. The classical analysis yields the correct result because the ground state is a non-statistical boundary, as shown in FIG. 4: ½-spin mass shift.

The neutron follows a similar analysis if one recognizes that if hydrogen has a ground state boundary, it will also have a near light speed saturation state boundary, with the proton and electron physical sizes determining the limit of relativistic contraction. The term “neutron” was first introduced by Harkins in 1921 as “one negative electron and one hydrogen nucleus,” Borghi theorized that neutrons were hydrogen states in 1941, and synthesized them in 1955 by EM stimulation, as did Missfeldt in Germany in 1979. Both approaches were low yield statistical processes.

The authors of this patent devised a high yield neutron synthesize process using EM conditions that entropically match hydrogen's “neutron” state, and then fused them to produce high energy Beta particles. The model assumed an Eₙ=mₙ−mₚ−mₑ=0.78233 MeV uniformly distributed 3-D electron ground state orbital energy, ⅓En=0.260777 MeV in 1-D, with no extra energy available to form statistical states.

Classically, a 1-D ⅓Eₙ=0.260777 MeV energy electron will undergo a Bohr kₑe²/r²=mv²/r coulomb-centripetal force interaction at a rₑ=rₒ(Eₒ/⅓Eₙ)=2.761 fm radius, where rₒ=0.528×10⁻¹⁰ m and Eₒ=13.6057 eV are hydrogen ground state conditions. The rₑ=2.761 fm orbit relativistically contracts by the (Eₙ+mₑ)/mₑ=2.531 electron energy increase to yield the rₙ=rₑ/2.531=1.091 fm observed neutron radius.

The relativistic contraction also results in the neutron½-spin by offsetting the proton mass from the center of the 2.761 fm radius electron orbit by its contraction of space, per a γ=√(1−vₑ²/c²) Lorentz transformation, so mₚ offsets by (rₑ=2.761 fm)−(rₙ=1.091 fm)=1.67 fm to yield an arc cos (rₑ−rₙ)/rₑ=53° spin vector. The neutron observes as a 1.091 fm radius because electron motion contracts space, so the proton moves to it, while the electron maintains its rₑ=2.761 fm radius orbit, so there always appears to be a spin vector offset to the mass of the 1.091 fm radius particle.

These results were calculated by simple classical principles, using the Eₙ=0.78233 MeV neutron state energy, but they don't explain where the En energy value derives from. The electron's orbital motion contracts space between the proton and electron, but does not contract the proton radius, and since the electron's motion acts on space, not itself because it is stationary relative to itself, it does not contract its radius either. Thus, the proton and electron radii are the determining factors of the Eₙ neutron state.

The proton and electron have rₚᵢ=1.02 fm and rₑᵢ=0.05 fm radii, so the two together occupy a minimum rₚᵢ+rₑᵢ=1.07 fm radius with no added tolerance to accommodate orbital variances. It is assumed that the (rₙ=1.09 fm)−1.07 fm=0.02 fm (40% of rₑᵢ) is what nature requires for orbital variations from the electron-proton interaction. Thus, the proton and electron sizes determine the degree of relativistic contraction, the electron velocity it derives from, and the Eₙ neutron state. The velocity, calculated by γ=√(1−vₑ²/c²) Lorentz transformation and ⅓En=½mₑvₑ² kinetic energy, works out to 2.754×10⁸ m/s, or 0.91864 c.

The same classical approach was used to calculate the neutron magneton based on the premise that the 2.561 Lorentz contraction constitutes an EM field energy density increase, and thus represents increased attenuation of the neutron orbital electron generated magneton, just as the EM field generated proton mass does to the quark triton generated magneton, mitigated by the proton's lower density with respect to the electron. Applying this reasoning to the μₙ=½eℏ/mp nuclear magneton yields a 4.83/2.53=1.91 times greater neutron magneton, in agreement with observed results, and a vector negative to the spin vector because it is generated by an electron.

While this classical framework analysis yields the measured parameters of the proton, electron, and neutron, it may be argued that a classical interpretation violates quantum theory. This objection fails however because quantum theory relies upon Boltzmann's P=e^{S/k} probability principle, in its S=k In P entropy form, as its fundamental basis. This means physical boundaries of the S entropic degrees of freedom are legitimate probability states, with ground state being the minimum possible system energy, and light speed being the maximum possible system energy, without statistical variations.

The concept of fusion was examined. Laboratory fusion has never proven viable after more than 60 years of efforts. Fusion works in stars and H-bombs as sustainable reactions, with consistent 600% exothermic yields in H-bombs, while laboratory reactions remain endothermic with less than 100% yields. These results constitute legitimate statistical data, endo and exothermic sides of a sustainability threshold that somehow depends upon each reaction's S=k ln P entropic conditions.

The basis for laboratory and H-bomb fusion appears to stem from Hans Bethe's 1939 statement that fusion is a thermonuclear process, since the argument to justify each new laboratory fusion project was that higher and high temperatures were needed to create a sustainable reaction. However, laboratory temperatures now far exceed star temperatures which supports a conclusion that “thermonuclear” is an effect, rather than a cause.

Next, the types of reactions involved were examined. Fusion in stars is fueled by plain hydrogen, while laboratory and H-bomb fusion are deuterium based, so fuel type does not appear to be a factor. This led to investigation of the reactions to identify a basis for sustainability. Stars form when hydrogen accumulates and gravity from its cumulative mass causes it to condense, creating a potential energy gradient which manifests as kinetic energy as objects fall through it, pointing to a relativistic basis, if neutrons constitute the saturation state of hydrogen, so gravity transforms hydrogen to neutrons, which readily fuse because they have no charge repulsion.

Stellar fusion negates charge repulsion by transforming hydrogen to a neutral state. The distinction between laboratory and H-bomb deuterium fusion was examined. Laboratory fusion takes two approaches: magnetic “pinch” to force deuterium nuclei to within bonding distance of each other and super heating with rf and laser energy to create thermonuclear temperature states. Neither approach addresses charge repulsion, and the problem is that the E=kₑe²/r charge repulsion energy at bonding distances equals the released bond energy, so the process never attains sustainability.

In the H-bomb, however, an entirely different approach is used. H-bombs work by detonating an A-bomb (fission reaction) around Lithium Deuteride, their reasoning being to compress the deuterium and generate neutrons from the lithium. However, if that worked then the laboratory “pinch” method would also be exothermic, and it's not. Instead what occurs is that the fission detonation causes the deuterium nuclei to move towards each other at light speed, which relativistically contracts space.

In this fusion reaction, two processes are at work, nuclear bonding which works at the nuclear bond distance corresponding to the ½-wavelength of a pion, and coulomb repulsion, which varies inversely with the square of the distance between the nuclei. When the light speed nuclei contract space it compresses the separation distance between the nuclei, so the pion can effectively interact with another nucleus, but the charge at the particles' surface interacts with space as if it is uncontracted because from its local perspective, space is uncontracted per Relativity: The laws of nature are the same in all inertial frames of reference.

This dynamic is because the impedance of space has been compressed, and per c=1/√μₒεₒ, if the density of the impedance of space increases, the velocity of light slows down, so from a charge perspective, the particles experience uncontracted space, and thus the e²/r² charge repulsion is much less when the nuclear bond occurs so the energy release is exothermic. There is also another factor called “quenching” at work in laboratory reactions. When a bond is formed, energy is released which acts to blow the particles away and quench the reaction, but in an H-bomb all nuclei are simultaneously forced together by the fission blast so they all react at the same time.

For this reason, laboratory deuterium fusion cannot achieve sustainability. It is not possible to simultaneously compress all the deuterium nuclei towards each other at light speed, to within their bonding distance, without a nuclear detonation. Accordingly, the authors of this patent took an alternate approach of synthesizing neutrons and reacting them to produce beta particles to induce lower energy electrons and produce electricity.

To achieve this, the authors use an electron gun to produce Eₑ=426 eV=6.8253×10⁻¹⁷ J electrons and a Cyclotron to produce Eₚ=0.7822 MeV=1.253 10⁻¹³ J protons, so the combined energy of any protonelectron pair is the Eₙ=0.78233 MeV neutron state energy, so Eₑ+Eₚ=Eₙ and Eₚ=(mₚ/mₑ) Eₑ, and their vₚ=vₑ=√(2Eₑ/mₑ)=√(2Eₚ/mₚ)=12.25×10⁶ m/s momentum velocities are equal.

The excited electrons and protons, are gated into pulses to limit quenching from neutron interactions, and ejected into a long reaction chamber as separate collimated beams. The electrons are deflected into the pulsed proton beam, where they accelerate toward the protons because of their charge, gaining energy by their “fall.” In this way, the electrons form “neutron states” with the protons because of opposite charges, instead of being repelled as with deuterium, and the particles' momentum energies are transformed into electron neutron state orbital energies.

These pulsed clusters of neutrons then interact among themselves because they have no charges to repel each other, producing a deuterium, tritium, helium-3 and helium-4 nuclei product spectrum, determined by a distribution of Beta particles centered around 2.2, 4, 7.5, 8 and 14 MeV energy peaks. These high-energy electrons are reduced to avalanches of low energy electrons by letting them interact with thin metal plates connected to current sources, to show that they could be used to generated electricity, like thermionic emissions, but using beta particles instead of heat.

The challenges associated with this process are that it produces gamma rays, the Beta particles have a wide statistical value range, and the particles emit in all directions, making them difficult to harvest. Because of these challenges, the authors of this patent decided to investigate the possibility of harnessing nuclear bond energy at the fundamental pion formation of the bond level, based on two factors: Synthesized neutrons form nuclear bonds, which means the pions interact with the neutron state orbital electrons, and all bonds are uniform and non-statistical in their ground state.

However, to utilize the concept of pion-electron interactions it was necessary to investigate pion generation to determine how to control it, one of the factors leading to the Nuclear-Gravitational Electrodynamic Framework based on the concept of coincident density ratios between ground and light speed states in the nuclear, atomic and gravitational domains.

The Correctness Probability for this framework calculates to over 99.99 . . . % because it yields the mass, charge, magneton, ½-spin and density energy parameters for the electron, quark and proton, the hydrogen atom parameters, earth's orbit, space's μₒεₒ impedance, the Higgs mass, distance of a light year, and the muon and pion energies, over 20 correct answers, and the

$${\sum }_{n = 0}^{n = 20} \frac{{x}^{n}}{n !} / {\sum }_{n = 0}^{n = ∞} \frac{{x}^{n}}{n !}$$

progression of energies of these parameters yields a value within 99.99 . . . % of e^{x}.

Based on this degree of certainty, the fact that proton-neutron bonds have consistent 2.224 MeV ground state energies, and that radiation only produces when a bond is formed, changes state, is broken, or when nuclei fragment, it was concluded that bond uniformity results from a pion emission-absorption energy resonance that results from an equilibrium between the proton's internal components and external neutron interaction, as shown in FIG. 5: Feynman Diagram and Deuterium bond.

In this model, the neutron state function of the neutron's orbital electron resonates between the particles at light speed, transferring the Down quark state between them, giving the electron an E_{bond}=2Eₙ+⅓Eₙ (Eₙ+mₑ)/mₑ=2(0.78233 MeV)+(0.260777 MeV) (2.531)=2.224 MeV bond energy, by simple classical analysis of two neutron states and the relativistic momentum energy of travelling between the particles. For this to be however, means that pion generation must also be a non-statistical ground state process, and that the pion interacts with and transfers energy to the electron.

This discovery and innovative model led to the quark triton configuration depicted in sections m, n, o and p above, generating the Higgs mass by orbital action of the +1e triton and generating the pion emission and absorption to and from the resonance electron as an integral process, so the pion generation is controlled by external circumstances, per Boltzmann's P=e^{S/k} probability principle, in which the electron's presence constitutes an entropic degree of freedom S for the pion's energy to flow to and derive from during resonance. Thus, the principle responsible for Chemical Thermodynamic molecular rearrangement is also responsible for controlling particle level pion probability.

The proton's 42.576 MHz/T Larmor Precession Frequency (LPF) exactly correlates to the rₚᵢ=1.027 fm proton radius and √2 spin offset by the a fine structure density factor according to rₚᵢ=(α³/ LPF)/(2π√2)=1.027 fm, meaning the 42.576 MHz rf were field matches the quark triton orbital rotation that generates the ½-spin offset of the Higgs mass its charge generates in our framework model. A design was configured from this to dynamically control pion-electron interactions by controlling the external circumstances of the proton's mass, charge, magneton, ½-spin and density energies:

a) To transfer energy from the pions to electrons to generate electricity;

b) To induce the pions to coherently emit gamma ray energy;

c) To interact electrons with pions to induce Electron Capture to form neutrons.

This completes the background section.

### SUMMARY OF THE DISCLOSURE

Controlling the protons' energies to reduce entropy: As shown in Background of the Invention, the proton's mass, charge, magneton, ½-spin and size/density parameters, its quarks, Higg's mass, pion generation, and Larmor frequency, are all explained and calculated in terms of space's impedance, the α density factor, and Boltzmann's P=e^{S/k} probability principle. Because of this, the fact that controlling external energy parameters in Chemical Thermodynamics (Boltzmann's probability principle) rearranges 10⁻¹⁰ m molecules, and the fact that Nuclear Magnetic Resonance controls particle behaviors by the same principle, it was concluded that best way to interact with pions is to control the proton's energy parameters.

Controlling all 5 parameters increases the P=e^{S/k} pion-electron interaction probability because it reduces the available S entropic degrees of freedom to 0, but the mass, ½-spin, and size/density parameters are a bit more difficult to deal with because there are no known primary energies that directly control them. Instead, because it was shown that they result from charge and magnetic field energies operating on space's impedance, it was decided that the best way to control them was to modulate the charge and magnetic field energies per the principles that resulted in them.

Cyclotrons introduce relativistic inertial mass energy by accelerating charged particles according to classical EM physics principles, the proton's Larmor frequency correlates to its radius by α and the other Nuclear-Gravitational Electrodynamic Framework principles, and ½-spin is a relativistic mass offset effect of the quark triton's light speed orbital contraction of space, which also generates the Higg's mass and proton's size, so it was determined that the same principles could be used to control the proton's mass, ½-spin and size/density parameters.

Controlling the mass, ½-spin and density energies to control pion generation: To control protons' mass, ½-spin and size/density parameters, sub-orbitals are incorporated into a Cyclotron orbital motion by splitting the Cyclotron Dees into ½-Dees and applying the Larmor frequency to each of them alternately. In this way, the superimposed sub-orbital gyrations create a centripetal accelerating force on the ½-spin mass offsets, thus orienting the ½-spin mass offset to the sub-orbital spin gyration. Thus, the offset mass responsible for the ½-spin effect becomes controlled by the sub-orbital centripetal force, and since the mass offset is generated by the light speed orbital quark triton, this provides controlled access to the quark triton's generated pion.

This construct resembles a 4-pole induction motor in which phase A and B operate at the Larmor frequency, synchronizing the proton spins, while the overall Cyclotron orbital motion occurs at half the Larmor frequency. The effect of this is to create two targets for the electron beam, or 4, or 8, depending on the number of poles implemented, and thus increase the synchronized pion interaction probability for the pulsed electron beam, just as induction motor rotors interact with the stator EM fields, so the statistical interaction probability increases accordingly.

Also, the half Dees' top and bottom surfaces and centripetal force holds the protons in planar orbitals, removing vertical dimension entropy, and since the force on the protons is a function of areas and distances, the increased area removes 2-D planar entropy from the interactions. Every available degree of freedom (the time dimension by increased interaction frequency, the vertical dimension by the top and bottom surfaces, and the two planar dimensions by the electrode areas) is utilized to control the charge, magneton, mass, ½-spin and density energy degrees of freedom of the protons and maximize electron-pion interactions, as shown in FIG. 4: Quad Pole Cyclotron.

Production of gamma rays, neutrons, or Beta particles by phased electron interactions: The ½-spin mass offset caused by the quark triton's light speed orbital contraction of space now places the triton at the sub-orbitals' outside surface, and since the tritons are the pion sources, the greatest pion-electron interaction probability occurs between the sub-orbitals, through the quad pole Cyclotron center. Because the sub-orbitals' Larmor frequency determines spin precession, the electron interaction angle is determined by the protons' sub-orbital phase position, creating acute interaction angles with inward momentum as the triton leaves the center region, obtuse interaction angles with outward momentum as the triton enters the center region, and an orthogonal interaction angle with no momentum at the center between the sub-orbitals region.

These three interaction results occur because of Wave-Particle Duality and because light waves have λ=h/mc momentum. In obtuse interaction energy transfers, electrons experience outward deflection momentums; in acute interactions, experience absorption momentums; and in orthogonal interactions the electrons experience pion energy transfer just as in nuclear bonds. Obtuse interactions are basically a nuclear bond breaking and yield gamma emissions; acute interactions absorb the electrons to form neutron states; and orthogonal interactions occur at the pion's matter wavelength node, so they are simple complete ΔE_{π} energy transfers, as shown in FIG. 7: Pion-Electron interaction angles and emissions.

Resolving opposing suborbital momentums: The sub-orbitals have opposing proton momentums in Cyclotron center because of the magnetic field, like opposing pistons in a reciprocating engine, so they cannot be allowed to interact with the electron beam at the same time. This requirement is achieved by synchronizing and gating the electron beam to the ½-orbital period of the Cyclotron, so the beam first interacts with one sub- orbital and then the other, and by alternately switching the A and B phases on and off so they are never on at the same time.

Modulating pion-electron interactions to produce gamma rays, neutrons or Beta particles: Thus, by aligning the protons' magnetons in a Cyclotron operating at half the Larmor frequency, alternately phasing the sub-orbitals on and off, with Larmor frequency half Dees, and gating the electron beam to the position phase of the Larmor frequency, the pion-electron interaction is modulated to produce gamma rays, neutrons, or high energy Beta particles.

### BRIEF DESCRIPTION OF THE DRAWINGS

FIG. 1: Quark Triton This drawing represents the minimum possible 3 quark ground state energy configuration (with no excited state momentum reversals), consisting of 3 m_{Up}=(E_{c}−Eₒ)√2√3 2π=3.9323 MeV minimum energy ground state Up quarks consisting of an electron Eₒ/α=(E_{c}−Eₒ)=0.2555 MeV light speed inertial 2π wave function with √2 angular and √3 spherical momentum distributions.

This places Up quarks solidly in the Nuclear-Gravitational Electrodynamic Framework of stable ground state constructs with Sommerfeld a fine structure constant density ratios separating the nuclear, atomic and gravitational energy domains: a 2π wave function, distributed in the 3 spatial and time dimensions as a 4-D space-time energy construct, with Wave-Particle Duality field energies and Eₙ=Eₒ/n² quantum states.

The Up quarks first quantum state is the m_{Down}=√3 m_{Up}=6.8109 MeV Down quark, occurs when the (√3−1)m_{Up}=m_{Down}−mUp=2.88 MeV orbital gluon binds the 3 Up quarks into a triton. It quantum optically exhibits as two +⅔ charge Up quarks and a −⅓ charge Down quark because the light speed gluon −1e charge wave function is always interacting with one Up quark, so they average to two +⅔ charge Up quarks and a −⅓ charge Down quark image over time. The gluon's light speed interaction with an Up quark precipitates a

$${m}_{{π}^{o}} = \sqrt{\frac{3}{2}} \{ ( \frac{3}{α} ) ( \frac{1}{2} {m}_{e} {c}^{2} ) + \sqrt{2} {m}_{e} \} + ( {m}_{Down} - \frac{{m}_{Up}}{π} ) = 135 MeV$$

neutral pion π° impulse energy emission.

FIG. 2: Impedance of space This figure shows Einstein's 4-D space-time points depicted as 4-D space-time point-pairs with bidirectional EM energy transfer capability. In this configuration, the point pairs can be operated upon by EM wave field energy to exhibit ↑↑ positive, ↑↓, neutral, or ↓↓ negative field energy, and still operate in the ↑↓, neutral state as Einstein's 4-D space-time points to exhibit as gravity.

FIG. 3: Quark Triton Generated Higgs Mass The quark triton +1e charge exhibits as a 2π wave function with light speed √2 angular and √3 spherical momentum distributions, resulting in alignment of space's point-pairs and field poles distributing at the c=1/√(μₒεₒ) light speed √3 spherical momentum distribution rate, so the poles reverse at light speed, within Heisenberg's ½ wave measurement Uncertainty, undetectable by normal means. However, if held in a magnetic field the energy distribution will exhibit as a μₚ=½ eℏ/mₚ magneton, attenuated by the proton's generated EM field energy Higgs mass, mitigated by the proton's lower density, as shown in Background of the Invention in [0006].

To be stable, the triton charge wavelength propagating through the mass must equate to the triton traversing ½ its circumference at light speed, so the ↑e⁺ charge motion force on one side attracts its opposing ↓e⁺ force. If E=hf=he/λ (Planck's equation), then a √3(2mUp+m_{Down})=25.4 MeV=4.07×10⁻¹² J triton with √2√3 angular and spherical momentums will generate a λ=hc/E=ℏc/[√3(2m_{Up}+m_{Down})√2√3 2π]=1.00942×10⁻¹⁵ m 2π wavelength, the rₚᵢ=(hc/α⁴)π²3^{2/3}/√2=1.02 fm proton radius minus the triton's r_{qi}=(r_{qo}/α)√3=6.35×10⁻¹⁷ m quark radii, and the mₚ(½=eℏ) √2√3 3c³=√3{(m_{Up}/α)+(m_{Down}−m_{Up})}=938.3 MeV proton mass minus the 25.4 MeV triton, factored by α, is the m_{HB}={mₚ−√3(2mUp+m_{Down})}/α=125.1 GeV Higgs mass.

FIG. 4: ½ spin mass shift FIG. 4 simply depicts the relativistic shift of the proton's mass by the quark triton's light speed orbital motion. Since the mass radius is rₚₒ=0.83 fm and the triton orbital radius occurs at the rₚᵢ=1.02 fm, the spin offset angle is arc sin rₚₒ/rₚᵢ=54.7°.

FIG. 5: Feynman Diagram and Deuterium Bond FIG. 5 depicts a proton-neutron Deuterium bond Feynman Diagram with particles exchanging states by exchanging Up and Down quarks via pion exchange, and the resonance of the neutron state ED=2Eₙ+Eᵣ=2(0.78233 MeV)+(Eₙ/3)(mₙ+Eₙ)/mₑ=2.224 MeV electron between the protons.

FIG. 6: Quad Pole Cyclotron FIG. 6 depicts a two phase 4-pole Cyclotron with alternating Larmor frequency sub-orbitals to control the protons' mass, ½ spin and density energies in order to synchronize the electron beam pulses with the quark triton pion generation, described in Summary of the Disclosure Section B.

FIG. 7: Pion-Electron Interactions Angles and Emissions FIG. 7 depicts interacting the electrons with the pions at different angles to obtain gamma rays, neutrons or high energy Beta particles, as described in Summary of the Disclosure Section in [0060].

The protons are subjected to centripetal force in the Larmor frequency sub-orbitals so their ½-spin offset mass, triton, and pion generation are on the outside of the orbital. The electron beam pulses are synchronized to control when the pions and electrons interact to introduce momentum into the electron to obtain the desired gamma, neutron or Beta particle emission.

FIG. 8: High and Low Energy Density Proton Cyclotron Standing Wave The two-phase Cyclotron design creates an energy standing wave that results in a quantized two state proton system that bunches the protons into groups. This way, when one of the phases is turned off, the protons stay in the low energy state and away from the electron beam so their opposing momentum pions cannot interact with electrons and generate gamma rays when they are used to generate electricity or neutrons. It is not dangerous to generate Beta particles when producing gamma rays, but it is dangerous to generate gamma rays when producing electricity.

Detailed Description of the Invention: As explained in the Background of the Invention and Summary of the Disclosure sections, a nuclear-atomic-gravitational framework was derived, showing that these domains are coincident energy constructs with stable non-statistical ground states separated by Sommerfeld's a fine structure constant density ratio, that particles are 2π wave function energy constructs operating in 4-D space-time as particles in a stable light speed resonance between 4-D space-time constructs and field energy forms (i.e. Wave-Particle Duality). Based upon this framework, the component energies of the proton were broken down into the simplest composite constructs that met the framework requirements. Einstein's 4-D Minkowski space-time was modified to incorporate EM fields, depicted in FIG. 2 as bi-directional Magnetic 4-D Minkowski space-time in which Einstein's points of space are uoco impedance point-pairs that can operate as ↑↑ positive, ↑↓ neutral, and ↓↓ negative field energy.

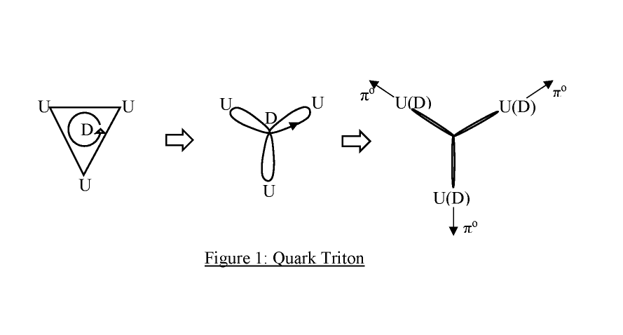

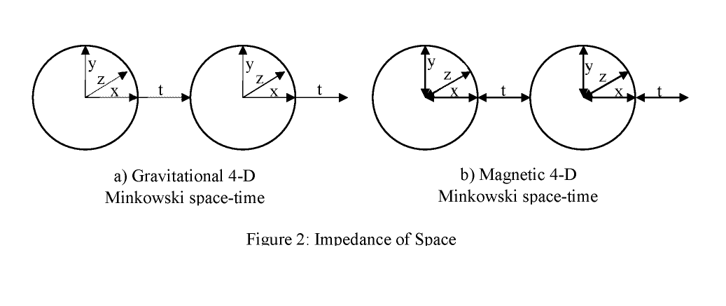

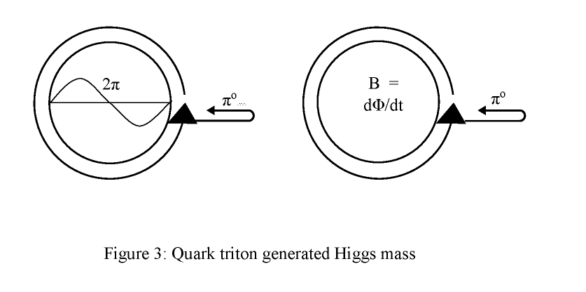

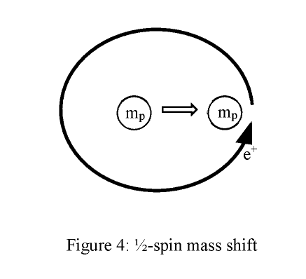

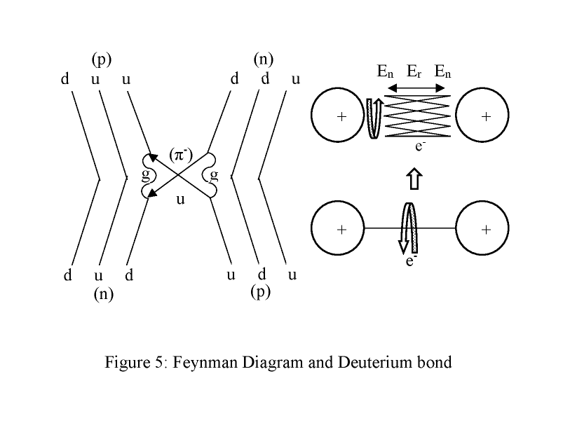

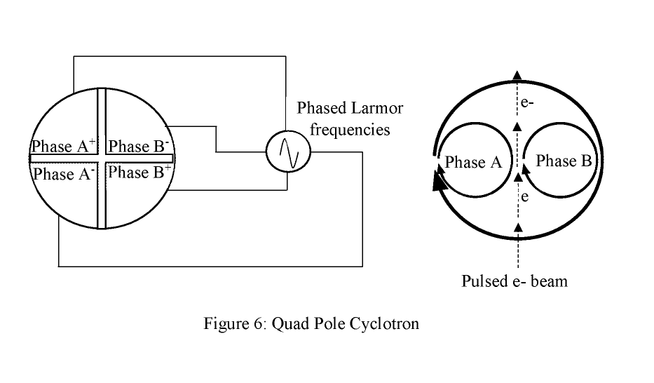

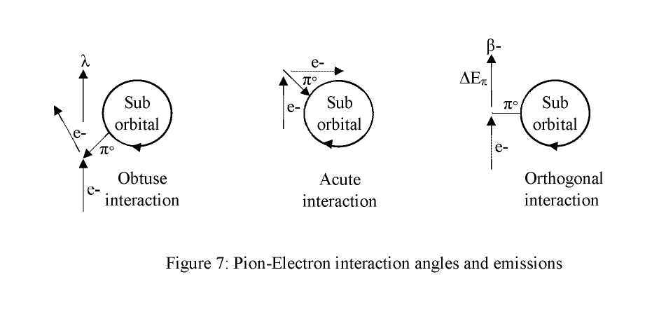

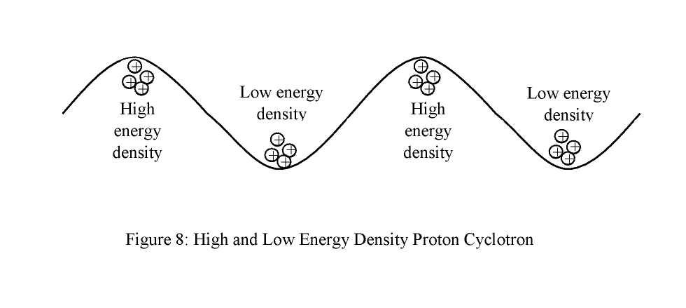

The proton Up, Up and Down quarks were configured as a composite triton structure of 3 ground state Up quarks bound by an excited Down quark state gluon resonating between the Up quarks, as depicted in FIG. 1, just as Yukawa's pion resonates between particles to bind them.

This composite quark triton structure is stabilized as part of the proton composite construct. As depicted in FIG. 3, the triton's charge and motion operate on space's impedance to generate the Higg's mass, appearing as neutral mass energy because the light speed orbital triton distributes in 3-D so the generated pole is cancelled at light speed, unless aligned in an external magnetic field, as the proton's magneton, attenuated by Higg's EM mass energy, mitigated by its lower density. In this process, the triton also creates the ½-spin mass offset, as depicted in FIG. 4, and the pion in nuclear bonds, depicted in FIG. 5 as a Feynman Diagram and Deuterium bond.

These depictions represent the minimum energy ground state configurations that result in proton mass, charge, magneton, ½-spin, density and pion energies, as per Background of the Invention and Summary of the Disclosure, yielding the quarks, triton and proton composite constructs, Wave-Particle Duality behaviors, and P=e^{S/k} Boltzmann Eₙ=Eₒ/n² quantum state distribution.

Wave behaviors and quantum states are 4-D space-time ground state construct derivatives (i.e. energy operating upon space's impedance and extra energy resulting in a P=e^{S/k} quantized wave function energy state distribution) so it is only necessary to control the ground state parameters to control the fundamental circumstance of all the quantum wave function energy states.

The objective is to align and orient protons' pions to interact them with electrons in a controlled way to produce electricity, gamma rays and neutrons, as shown in FIG. 7, where the angle of interaction determines whether the output is gamma rays (obtuse interaction), neutrons (acute interactions) and high energy Beta particles to generate electricity (orthogonal interaction):

Since Chemical Thermodynamics techniques based on Boltzmann's P=e^{S/k} probability principle are used to rearrange molecules, and particles behave per the same Boltzmann quantum statistics principles, the same approach is utilized to control the interaction alignment and orientation. This was accomplished by a combination of Cyclotron with sub-orbital sub-Cyclotron ½-Dees and Nuclear Magnetic Resonance Techniques, as shown in FIG. 6:

A 2.5″ standard Cyclotron configuration is used, except that the Dees are split in half to effect Cyclotron sub-orbitals. The 2.5″ ½-Dees were made of copper sheet with a ¼″ gap. Neodymium super magnets were used to achieve a 1 Tesla field strength. In this configuration, there are three synchronized momentums occurring: 1) A fundamental half Larmor frequency Cyclotron orbital; 2) Larmor frequency sub-orbitals; and 3) Nuclear Magnetic Resonance Larmor frequency spin.

All three momentums are synchronized, with two proton spin (and pion generation) sub-orbital revolutions per Cyclotron orbital, so internal and external proton behaviors are in equilibrium, and the P=e^{S/k} alignment and orientation probability are maximized.

A phase controlled electron beam, pulse synchronized to the Larmor frequency, and gated to the Cyclotron 1/2 Larmor frequency, passes between the phase A and B ½-Dees to interact with the quark triton generated pions, as the protons traverse the sub-orbital coincident with their ½-spin Larmor precession. The tritons and their relativistically attracted Higgs mass are accelerated to the orbital's outside surface by the sub-orbital angular momentum and their ½-spin mass offset.

This maximizes electron-pion interactions, but excludes opposing momentum pions by turning off Phase A and B ½-Dees Larmor frequency alternately so Beta particles and gamma rays aren't simultaneously generated. The protons are gated into groups because the sub-orbitals operate at the Larmor frequency and the Cyclotron operates at half the Larmor frequency, so the sub-orbital protons have twice the E=hf energy, an excited quantum state that removes entropy from proton pion generation by keeping the protons in the Cyclotron plane, accelerating angular momentum to keep the triton's pion generation on the outside of the sub-orbital surface, and moving them into path of the electron beam pulses when it is time for the electrons to interact with them.

This configuration acts to synchronize the tritons' pion generation with the electron beam pulses because interaction of the 2.88 MeV gluon with a 3.9322 MeV Up quark to form a 6.8109 MeV Down quark state constitutes a 73% mass-energy increase for the Up quark so it is accelerated to the sub-orbital's outside surface along with the triton and relativistically generated ½-spin Higgs mass offset. The protons are also bunched into higher energy lower entropy groups because the ½-Larmor frequency Cyclotron orbital and Larmor frequency sub-orbitals form a high and low energy density proton Cyclotron standing wave, as shown in FIG. 8, and since these are the only two possible energy states in the configuration, the protons distribute evenly between the states per Boltzmann's P=e^{S/k} probability principle.

Thus, the generated pions are orchestrated into position for optimum interaction with the electron beam pulses in the center between the phase A and B ½-Dees, and when the Larmor frequency is alternately turned off entropy increase for those protons and they move to the Cyclotron orbital where they behave randomly, away from the electron beam. The interaction product (emission) is determined by the interaction angle, as shown in FIG. 7, gamma rays for obtuse interactions, neutrons for acute interactions, and Beta particles for orthogonal interactions.

Gamma, Beta and neutron detector feedback is used to optimize the interaction angle by phasing the electron beam pulses forward or backward to minimize the undesired energy forms. This allows a high degree of gamma ray frequency and direction control, per Bragg's equation, like X- ray generation and diffractometry techniques, because the pion-electron interaction angle constitutes a reaction surface determined by the protons' generated pions' reduced entropy.

It doesn't matter if both the pion matter wave angle and electrons move relative to each other if their motions are uniform, which they are because the electron beam is constant energy and the protons' spin occurs at the Larmor precession rate. When an electron beam interacts with a metal target to produce x-rays the target's orbital electron motions are random but their crystal lattice spacing has 0-entropy. In this case the protons are “bunched” and their pion generation entropy is near 0 so they have lower entropy than orbital electrons, and provide a better interaction surface.

Whether electrons interact with pions to produce gamma rays or orbital electrons to produce X- rays, the output is electromagnetic in either case under obtuse angle conditions, but are coherent in the case of gamma ray generation because all conditions are controlled, like creating uniform energy barrier Avalanche conditions in a solid-state lasers' crystal lattice. However, coherent gamma rays are strongly attenuated by the random dispersion properties of atmospheric gases.

This is minimized by modulating the gamma ray generation to the gasses' matter wave frequency to reduce entropic losses. This reduces overall efficiency, but aligning the matter waves forms a conduit for the gamma rays to pass through, and their energy from the pions is in the order of a 2 MeV nuclear bond while the matter waves are in the order of 10 eV, so it's relatively efficient.

The gasses have a statistical distribution of matter wave frequencies centered about an average frequency corresponding to the ambient temperature. Generating the gamma rays in pulses that correspond to the ambient matter wave frequency tunes gamma ray generation to the wavelength most likely to be absorbed by the gases, so their energy absorption entropic degree of freedom saturates, and they stop absorbing energy around the beam, creating a net conduit effect.

Neutrons are similarly generated, except that the electron-pion interactions are tuned for an acute interaction angle that results in the electron being absorbed into a neutron state orbital. Neutrons were synthesized by Borghi by microwave stimulation of hydrogen in 1955, and again by rf field stimulation of hydrogen by Missfeldt in 1979, but these were very inefficient statistical synthesis processes. The authors of this patent used an Electron Gun and Cyclotron to generate specific energy protons and electrons, interacted at an acute angle, to produce neutrons more efficiently, but this electron-pion interaction method is nearly 100% efficient.

Electricity is generated by interacting the electrons orthogonal to the pions, as shown in FIG. 7. An orthogonal interaction transfers the pion's 2.2 MeV matter wave energy to the electrons, with no angular momentums to produce gamma rays or form neutrons. These 2.2 MeV Beta particles strike a series of metal plates attached to a current source, so they create an electron cascade that distributes the 2.2 MeV between them, for instance a 2.2 MeV Beta particle creating a cascade of 500 electrons with an average energy of 4400 eV. This technique therefore transforms Beta particles into high current pulses, like switching power supply pulses averaging to a sign wave.

As shown in the FIG. 5 Feynman Diagram, there is a Down quark energy state transfer which corresponds to the 2.88 MeV gluon energy, comprised of a Eₙ/3 (Eₙ+mₑ)/mₑ=0.66 MeV 1-D resonance energy and 2.22 MeV bond energy, so 2.22 MeV+0.66 MeV=2.88 MeV. The 2.22 MeV transfers to the electron from the proton via the pion matter wave because of the proton and electron charge difference, and the 0.66 MeV 1-D momentum energy returns to the proton.

This process occurs at 1 fermi=10⁻¹⁵ m distances, but functions like Chemical Thermodynamic reactions at the 10⁻¹⁰ m distances of atoms. Conditions are orchestrated to create Boltzmann S=k ln P entropic conditions that favor the desired outcomes. In either case, the reactions occur between electrons (or electrons and pions) with entropic conditions controlled to favor desired products, as in fractionating columns where desired products are extracted, and in this case, is removed as a gamma ray, Beta particle, or neutron emissions, and as the desired products are removed from the reaction, more are produced to maintain the P=e^{S/k} entropic equilibrium probability. This completes the detailed description of the invention.

1- Producing Electricity by Controlled Pion-Electron Interactions

2- Producing Coherent Gamma Rays by Controlled Pion-Electron Interactions

3- Producing Proton to Neutron Transmutations by Controlled Pion-Electron Interactions
